(19) United States
(12) Patent Application Publication
(10) Pub. No.: US 2014/0069741 A1
(43) Pub. Date: Mar. 13, 2014

(54) Rescue Method and Rescue Device

(71) Applicants: Uwe Bergmann, Melle (DE); Dirk Bergmann, Spenge (DE)

(72) Inventors: Uwe Bergmann, Melle (DE); Dirk Bergmann, Spenge (DE)

(21) Appl. No.: 14/119,274

(22) PCT Filed: May 21, 2012
(86) PCT No.: PCT/EP2012/059409

§ 371 Date: Nov. 21, 2013

(30) Foreign Application Priority Data
May 25, 2011 (DE) 10 2011 050 630.6

(51) Int. Cl. A62B 1/14

(52) U.S. Cl. CPC A62B 1/14
USPC 182/129; 182/241

(57) ABSTRACT

A method of rappelling loads (18) from a platform, includes the steps of lowering a rappelling rope (22) from the platform, controlled rappelling of a tension weight (26), that is connected to the rope (22) by a brake unit (28) for limiting the rappelling speed, into a lower end position on the rope, and rappelling at least one load (18) via the rope (22) before the tension weight (26) has reached its lower end position.

The invention relates to a method and device for rappelling loads, in particular persons, from a platform.

Such rescue devices are needed for example for the servicing personnel of wind power plants. Modern wind power plants with a power capacity of several megawatts may have hub heights of up to 160 m and are installed both onshore and offshore for generating electricity. These plants have, at the tip of the tower, a relatively large engine house that may accommodate up to 30 persons during maintenance works. By employing a large number of staff for maintenance and repair, the dead times shall be minimized.

Typically the engine house of the wind power plant can be accessed via a ladder equipped with a climb protection system, or via a person lift inside the tower. In an emergency case, e.g. fire in the engine house or the tower base, it must be assured that all persons that are present in the plant can readily be rescued via an alternative rescue path.

DE 20 2010 002 467 U1 discloses a rescue device that comprises a reel for a rappelling rope, mounted on the platform, a weight attached to the lower end of the rope, and a tensioning device arranged near the lower end of the rappelling rope and adapted to hold the rope under tension even when the weight is subject to a supporting force.

When the device is to be put to use, at first the rappelling is unwound by means of the reel that is mounted on the platform, e.g. in the engine house in the gondola of a wind power plant, until the weight reaches the ground or, in case of offshore plants, the water surface, and the experiences a supporting force because the weight rests directly on the ground or the weight is configured as a rescue raft and equipped with bouyancy bodies and floats on the water surface. Then, the tensioning device assures that the rope is held under a certain tension even in this condition, so that the load that is being rappelled will not collide with the tower or other obstacles but can be grounded in a controlled manner. The load may be attached to a brake unit by means of a harness, and the brake unit will run down along the rope with limited speed. By utilizing a larger number of brake units it is possible to rappel a plurality of persons in rapid succession. It is therefore an object of the invention to provide an apparatus that permits to safely rappel persons and other loads and has a high transport capacity.

It is an object of the invention to provide a device that permits to rappel the loads even faster.

According to the invention, this object is achieved by a method that comprises the following steps:
lowering a rappelling rope from the platform,
controlled rappelling of a tension weight to a lower end position at the rappelling rope, the weight being attached to the rope with a brake unit for limiting the rappelling speed, and
rappelling at least one load at the rope before the tension weight has reached its lower end position.

It is an essential advantage of this method that the rappelling rope does not have to be unwound and lowered from a reel in a time consuming manner but may simply be dropped. Since no weight is yet suspended from the rope at this stage, there is no risk that, when the rope is dropped, a shock occurs that could cause the rope to brake. Since the tension weight is rappelled thereafter in a controlled manner, i.e. with limited speed, only a gentle shock will occur when the tension weight reaches the lower end position, and no substantial swinging movement of the rope will be induced. Since the upper section of the rappelling rope, through which the tension weight has passed already, is already under tension, it is possible to start with rappelling the loads while the tension weight still continues to move downward. In this way, considerable time savings can be achieved.

In case of onshore rappelling the length of the rope may be selected such that the tension weight will hover somewhat above the ground in the lower end position. Alternatively, the tension weight may rest on the ground and may contain a tensioning device for the rope.

When the platform is installed above a water surface, the length of the rope is preferably selected such that the tension weight will be slightly below the water surface in the lower end position.

A device that is suitable for carrying out this method is claimed in the independent device claim.

Useful details and further developments of the invention are indicated in the dependent claims.

An embodiment example will now be explained in conjunction with the drawings, wherein:

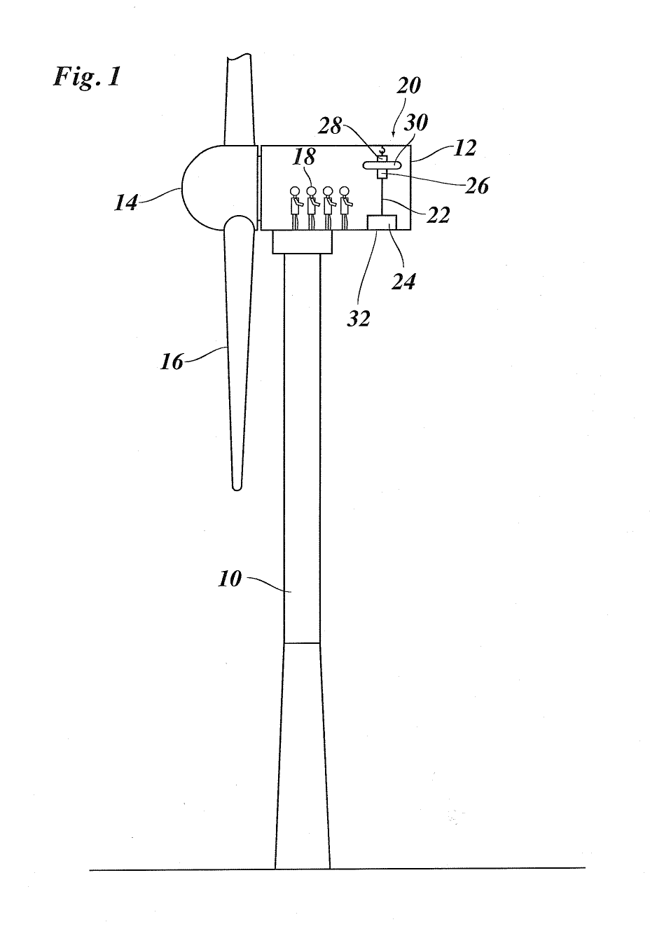

FIG. 1 is a sketch of an offshore wind power plant having a rescue device according to the invention; and

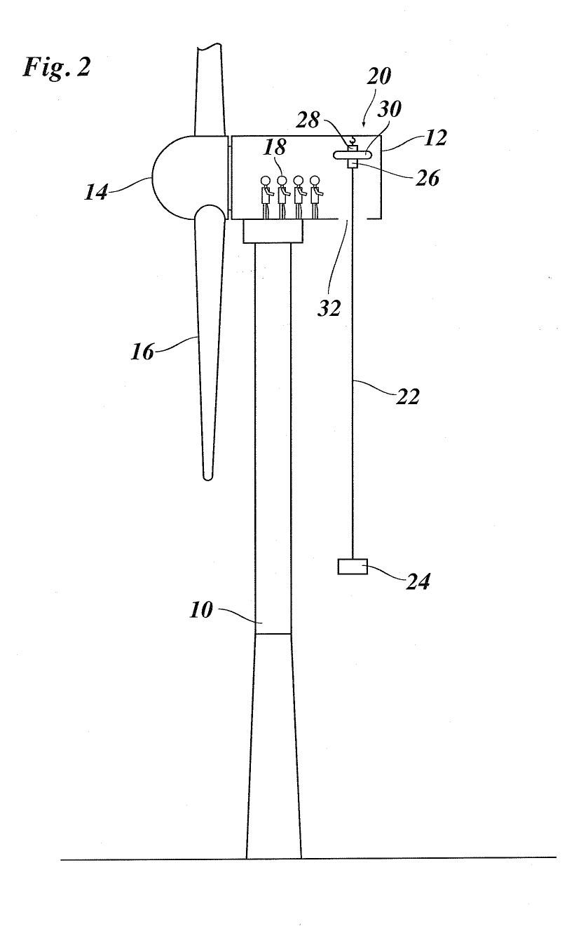

FIGS. 2-5 are sketches analogous to FIG. 1, for illustrating the process flow.

FIG. 1 schematically shows an offshore wind power plant comprising a tower 10, a gondola 12, a hub 14 and rotor blades 16. The gondola 12 accommodates an engine house in which a larger number of persons 18 may be present during maintenance and repair works.

The wind power plant has a rescue device 20 permitting to evacuate the maintenance personnel in an emergency case, e.g. in case of fire in the engine house, in shortest possible time via a separate rescue path (that does not pass through the interior of the tower 10). This rescue device comprises a rappelling rope 22, a rope storage device 24, and a tension weight 26 that is attached to the rope 22 with a brake unit 28. In the example shown, a rubber boat or rescue raft 30 is arranged, at first in a collapsed condition, between the tension weight 26 and the brake unit 28.

For reasons of fire safety, the rappelling rope 22 should preferably be a steel rope. One end of the rope 22 is safely attached to the gondola 12, e.g. at the roof of the engine house. The other end of the rope is at first accommodated in the storage device 24 that is also stored inside the gondola 12. The storage device may for example be a drum or simply a box that accommodates the rope in a flaked or coiled state. If the storage device accommodates a rope coil, this is preferably coiled with a certain twist for improving the unwinding properties. In the simplest case, the storage device may be a belt that holds the rope in a coiled state or flaked as a packet and that is removed or cut-through when the rescue device is to be used. The tension weight 26 and the rescue raft 30 are held by means of a brake unit 28 at a section of the rope 22 between the top end and the section accommodated in the storage device 24.

The rescue device 20 may be installed permanently in the gondola 12. It is possible, however, to retrofit an existing wind power plant with the rescue device 20. Likewise is it possible that the servicing personnel brings the rescue device 20 and installs it in the gondola 12 when the maintenance works are to start.

In the example shown the storage device 24 is formed by a box that is detachably held in a porthole 32 formed in the floor of the gondola 12. When the persons 18 are to be evacuated, the storage device 24 is detached from its holder and dropped so that it clears the porthole 32 as shown in FIG. 2. While the top end of the rope 22 remains attached to the gondola 12, the storage device 24 moves down due to its own weight and the weight of the rope accommodated therein, the rope 32 being progressively drawn out of the storage device 24. The storage device may be designed such that the withdrawal of the rope is braked to some extent and consequently the fall velocity of the rope is controlled.

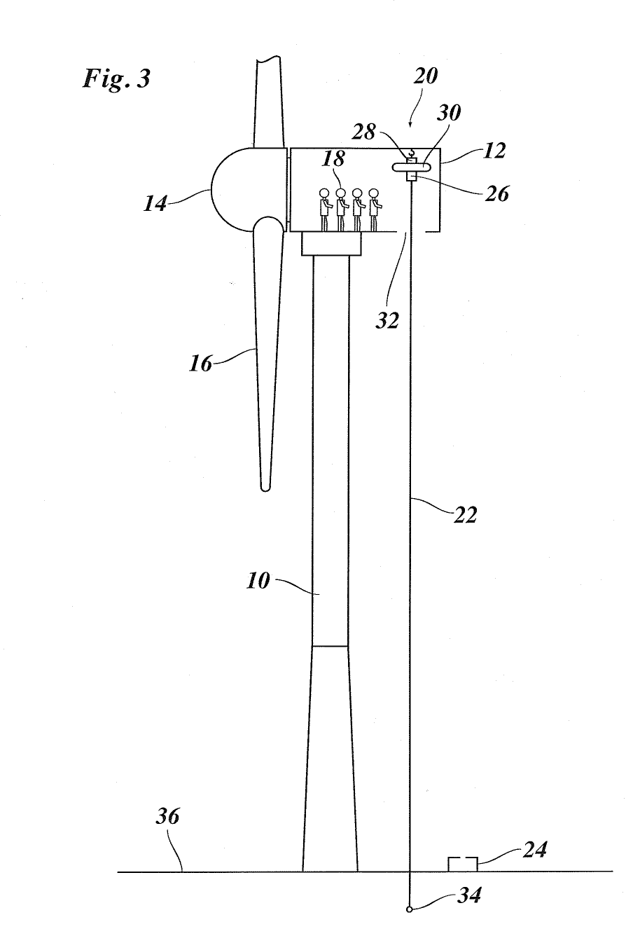

In FIG. 3 the rappelling rope 22 has been withdrawn completely from the storage device 24 and depends freely from the gondola 12. The length of the rope 22 is selected such that its lower end, to which a stop 34 is attached, is somewhat below the water surface 36. The storage device 24 has fallen off and floats on the water surface.

In this state, a lock that has fixed the brake unit to the rope 22, e.g. by means of a clamping mechanism, is detached, so that the brake unit 28 with the tension weight 26 and the rescue raft 30 attached thereto starts to move down along the rope 22. The brake unit 28 includes a brake, e.g. a centrifugal brake, that limits the rappelling speed of the tension weight 26. The brake unit 28 may be clamped detachably to the rope 22 so that it is possible, in a modified embodiment, that the brake unit and the tension weight 26 are attached to the rope 22 only at the time when the rope has been dropped and withdrawn from the storage device.

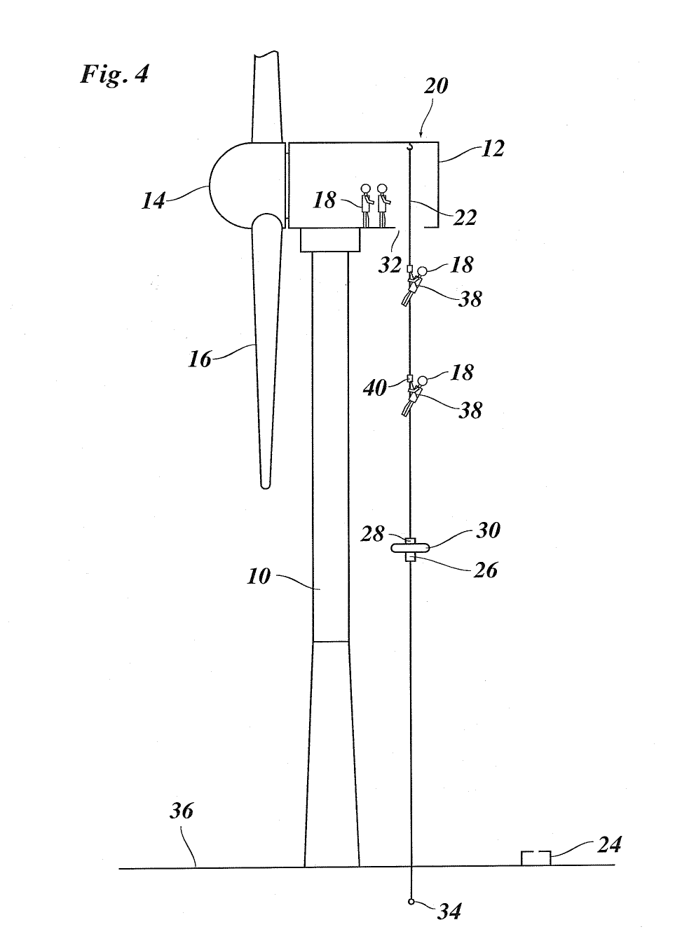

FIG. 4 shows the rescue device in a state in which the tension weight 26 moves down along the rappelling rope 22 with a speed that is limited by the brake unit 28. The part of the rope 22 that is still below the tension weight 26 is not subject to any substantial tension forces. In contrast, the part of the rope above the tension weight 26 is tensioned by the tension weight 26 and is thereby stabilized in its position such that it extends vertically downward from the porthole 32.

In this condition, it is possible to start already with evacuating the persons 18, even though the tension weight 26 had not yet reached the lower end of the rope. To that end, each person 18 puts on a harness 38 that is connected to a brake unit 40. The brake unit 40 may have a design similar to that of the brake unit 28 but may be designed for a lower weight. For example, the brake unit 40 includes clamping rollers (not shown) with which it is clamped to the rope 22 so that it can roll down along the rope in a controlled manner. Further, the brake unit 40 includes a brake, e.g. a centrifugal brake, that limits the speed with which the brake unit moves down along the rope 22 to a maximum value of 2 m/s for example. This maximum value should be slightly lower than the maximum speed to which the brake unit 28 for the tension weight 26 has been calibrated. In this way, the persons 18 can be rappelled one after another via the rope 22 without running onto the tension weight 26. In FIG. 4, two persons 18 are being rappelled already along the rope 22. The remaining persons may follow in suitable intervals.

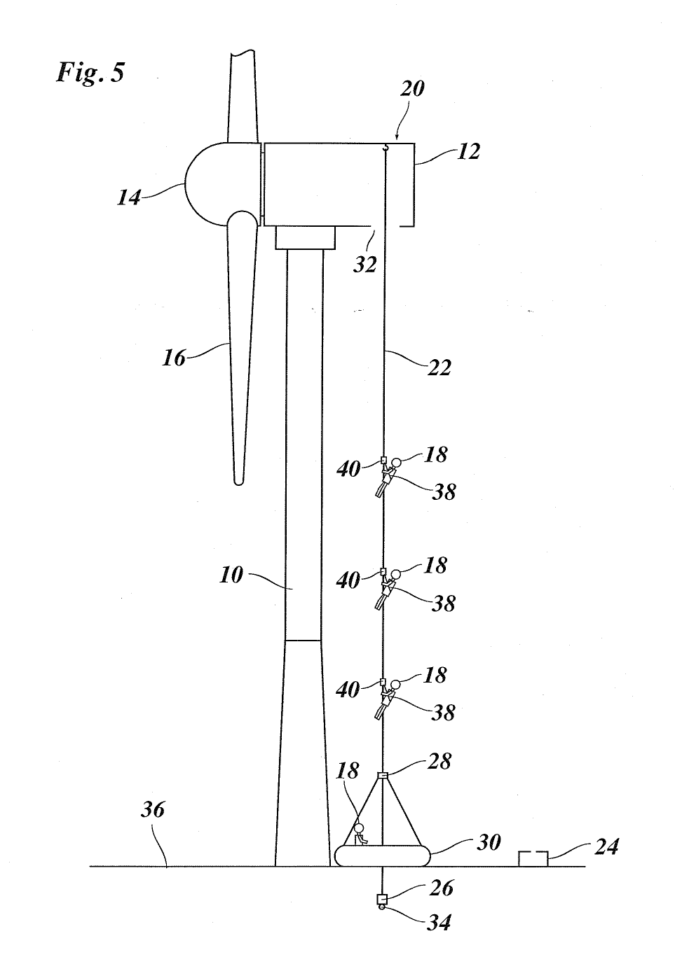

In FIG. 5 the tension weight 26 has reached its lower end position on the rappelling rope 22. The tension weight 26 is stopped in this end position by the stop 34. The impact of the brake unit 28 on the stop 34 triggers the automatic deployment and inflation of the rescue raft 30. The rescue raft floats on the water but is still connected to the rope 22 by the brake unit 28. For example, the rope passes through a valve or a water-tight feedthrough in the bottom of the rescue raft 30 towards the tension weight 26. This assures that, in this condition, the tension weight 26 still exerts a tensioning force on the rope 22 and holds the same in a tensioned state so that the following persons 18 may be rappelled safely until they have reached the rescue raft.

When all persons have been rappelled into the rescue raft 30, the brake unit 28 may be detached from the rope and the tension weight may be dropped in order to free the rescue raft from the rappelling rope. A suitable trigger mechanism may be provided for dropping the tension weight, or the tension rope may be cut-through above the floor of the rescue raft.

The embodiment example that has been described above may be modified in various ways.

For example, the rope storage device 24 may be connected non-detachably to the lower end of the rope 22. In this case, the storage device may also fulfill the function of the stop 34.

On the other hand, it is possible that the storage device 24 is installed permanently in the gondola 12 and the rope 22 is simply dropped out of the storage device when the evacuation begins.

What is claimed is:

1. A method of rappelling loads from a platform, comprising the steps of:
lowering a rappelling rope from the platform,
controlled rappelling of a tension weight, that is connected to the rope by a brake unit for limiting a rappelling speed of the tension weight to a lower end position on the rope, and
rappelling at least one load via the rope before the tension weight has reached its lower end position.

2. The method according to claim 1, wherein the rope is attached to the platform at one end of the rope, and further comprising the step of withdrawing a major part of the tension rope from a rope storage device while the rope is lowered from the platform.

3. The method according to claim 2, further comprising the step of dropping the storage device from the platform in order to lower the rope.

4. The method according to claim 1, further comprising the step of selecting the length of the rope such that the tension weight is located slightly above a ground surface in the lower end position.

5. The method according to claim 1, further comprising the step of selecting the length of the rope such that the tension weight rests on a ground surface in the lower end position, and the rappelling rope is held under tension by a tensioning device integrated into the tension weight.

6. The method according to claim 1, further comprising the step of selecting, for offshore rappelling, the length of the rope such that the tension weight is below a water surface in the lower end position.

7. The method according to claim 6, further comprising the step of combining the tension weight with a rescue raft which is deployed into a floating state when the lower end position is reached.

8. A device for rappelling loads from a platform, comprising:
a rappelling rope adapted to be connected to the platform,
a tension weight suspended from the rappelling rope,
a brake unit which connects the tension weight to the rappelling rope and which is adapted to move down along the rope towards a lower end position with limited speed.

9. The device according to claim 8, wherein the rappelling rope is a steel rope.

10. The device according to claim 8, further comprising a rescue raft combined with the tension weight.

11. The device according to claim 8, further comprising a plurality of brake units that are adapted to be detachably clamped to the rappelling rope and to which a respective load can be attached and which are adapted to move along the rappelling rope with a speed that is limited by a brake action.
